(19) United States
(12) Patent Application Publication
(10) Pub. No.: US 2025/0309314 A1
(43) Pub. Date: Oct. 2, 2025

(54) IMPACT RECEIVING STRUCTURE OF FUEL CELL STACK AND METHOD FOR MOUNTING IMPACT RECEIVER OF FUEL CELL STACK

(71) Applicant: HONDA MOTOR CO., LTD., Tokyo (JP)

(72) Inventors: Yuta OSHIMA, Wako-shi (JP); Takuma NOZAKI, Wako-shi (JP); Kazuma HIROE, Wako-shi (JP); Tadashi NISHIYAMA, Wako-shi (JP)

(21) Appl. No.: 19/064,141

(22) Filed: Feb. 26, 2025

(30) Foreign Application Priority Data
Mar. 29, 2024 (JP) 2024-057664

(51) Int. Cl. H01M 8/248; H01M 8/0284; H01M 8/10; H01M 8/241; H01M 8/2475

(52) U.S. Cl. CPC H01M 8/248; H01M 8/0284; H01M 8/241; H01M 8/2475; H01M 2008/1095

(57) ABSTRACT

Provided is a method for disposing a buffer member in a stack case with high accuracy without damaging the buffer member due to contact between the buffer member and a side surface of a stacked cell. A structure of a fuel cell stack includes a stacked cell configured by stacking a plurality of power generation cells, a stack case in which the stacked cell is accommodated, and a buffer member disposed at an inner wall corner of the stack case. Herein, the buffer member includes a resin member disposed to face the inner wall corner, and an elastic member disposed between the resin member and an inner wall surface of the stack case. The elastic member is fitted into and held by a groove provided on the inner wall surface of the stack case.

### CROSS-REFERENCE TO RELATED APPLICATIONS

This application is based upon and claims the benefit of priority from Japanese Patent Application No. 2024-057664 filed on Mar. 29, 2024; the entire contents of which are incorporated herein by reference.

### BACKGROUND OF DISCLOSURE

### 1. Technical Field

The present disclosure relates to an impact receiving structure of a fuel cell stack and a method for mounting an impact receiver of a fuel cell stack.

### 2. Description of Related Art

Conventionally, in an assembly process of a fuel cell, a positioning guide is provided in a stack case, a positioning hole is provided in a flat plate-shaped component forming the fuel cell, and the flat plate-shaped components are sequentially stacked to form a cell. Herein, a method for forming a fuel cell by repeatedly stacking the predetermined number of cells is known.

For example, an abstract of Japanese Unexamined Patent Publication No. 2013-196849 discloses “A method for assembling a fuel cell stack, which includes a step of arranging knock pins for positioning unit cells, a step of stacking the unit cells, and a step of compressing the unit cells. The knock pin includes a knock pin main body disposed in a positioning hole of the unit cell after the compressing step, and a first extending portion and a second extending portion which are attachable-detachable and disposed at both ends of the knock pin main body. The assembling method includes steps of detaching the first extending portion and detaching the second extending portion in a state that the unit cells are compressed after the compressing step.”

### SUMMARY OF DISCLOSURE

Each unit cell is formed by a membrane electrode assembly and separators holding the membrane electrode assembly from both sides. The separator is formed of a metal separator such as a steel plate, a stainless steel plate, or an aluminum plate.

Here, when the unit cells are stacked, desirably the metal separator does not contact an impact receiving member (hereinafter, referred to as a buffer member) located between the stack case and the unit cells. When the metal separator slides with respect to the buffer member, the metal separator scrapes a resin member, and resin powder is mixed into the stack case, possibly resulting in adverse effects of power generation.

Further, if the stack case encounters a strong impact such as a collision, there is a concern that separation of the stacked cell (i.e., it is a cell formed by the unit cells thus stacked) from the buffer member may cause a position displacement of the stacked cell. If the stacked cell causes a position displacement, there is a risk that the fuel gas leaks.

In this case, desirably, a distance between the stacked cell and the buffer member is set to, for example, several [mm] or less, and preferably 1 [mm] or less. However, it is difficult to insert and dispose the buffer member between the stack case and the stacked cell after the unit cells are stacked, from a viewpoint of ensuring a clearance.

Although it is conceivable to attach an elastic member between the stack case and the stacked cell, the elastic member has problems that durability thereof is not preferable and that accuracy of the attachment position is not good when considering an influence of a thickness of an adhesive or the like.

The present disclosure has been made in view of the above circumstances. An object of the present disclosure is to provide an impact receiving structure of a fuel cell stack and a method for mounting an impact receiver of a fuel cell stack, the method capable of installing a buffer member in a stack case with high accuracy without damaging the buffer member due to contact between the buffer member and a side surface of a stacked cell.

That is, the impact receiving structure of the fuel cell stack includes a stacked cell configured by stacking a plurality of power generation cells one another, a stack case accommodating the stacked cell, and a buffer member disposed at an inner wall corner of the stack case. Herein, the buffer member includes a resin member disposed to face the inner wall corner and an elastic member disposed between the resin member and an inner wall surface of the stack case. Further, the elastic member is fitted into and held by a groove provided on the inner wall surface of the stack case.

According to the present disclosure, the buffer member can be installed in the stack case with high accuracy without being damaged by contact between the buffer member and the side surface of the stacked cell.

### BRIEF DESCRIPTION OF DRAWINGS

FIG. 1 is a top view of a fuel cell stack according to a first embodiment;

FIG. 2 is a partially enlarged view of a lower right end of FIG. 1.

FIG. 3 is an explanatory view showing a configuration in which an adjustment mechanism is provided at a corner of a stack case;

FIG. 4 is an explanatory view showing a state in which an elastic member of a buffer member is fitted into a groove provided on an inner wall surface of a stack case;

FIG. 5 is a partially enlarged view of a portion showing that the elastic member of the buffer member of FIG. 4 is attached to the groove of the inner wall surface.

FIG. 6A is a flowchart showing a method for attaching the buffer member to an inner wall surface of the stack case in the fuel cell stack.

FIG. 6B is a flowchart showing details of a stacked cell disposing step (step S003).

FIG. 7 is an explanatory view showing an impact receiving structure of a fuel cell stack according to a second embodiment.

FIG. 8 is an explanatory view showing a configuration that a groove of an inner wall surface is formed in a tapered shape and an elastic member is also formed in a tapered shape.

FIG. 9 is an explanatory view showing a configuration that a groove of an inner wall surface is formed in an inverted taper shape and an elastic member is also formed in an inverted taper shape.

FIG. 10 is an explanatory view showing an impact receiving structure of a fuel cell stack according to a third embodiment;

FIG. 11 is an explanatory view showing an impact receiving structure of a fuel cell stack according to a fourth embodiment;

### DESCRIPTION OF EMBODIMENTS

Hereinafter, embodiments for carrying out the present disclosure will be described in detail. The embodiments described below are merely examples for realizing the present disclosure, and should be appropriately modified or changed depending on construction of a device to which the present disclosure is applied and various conditions. The present disclosure is not limited to the above embodiments. In each drawing, the same components are denoted by the same reference numeral, and the description thereof will be appropriately omitted.

### First Embodiment

### [Construction of Fuel Cell Stack]

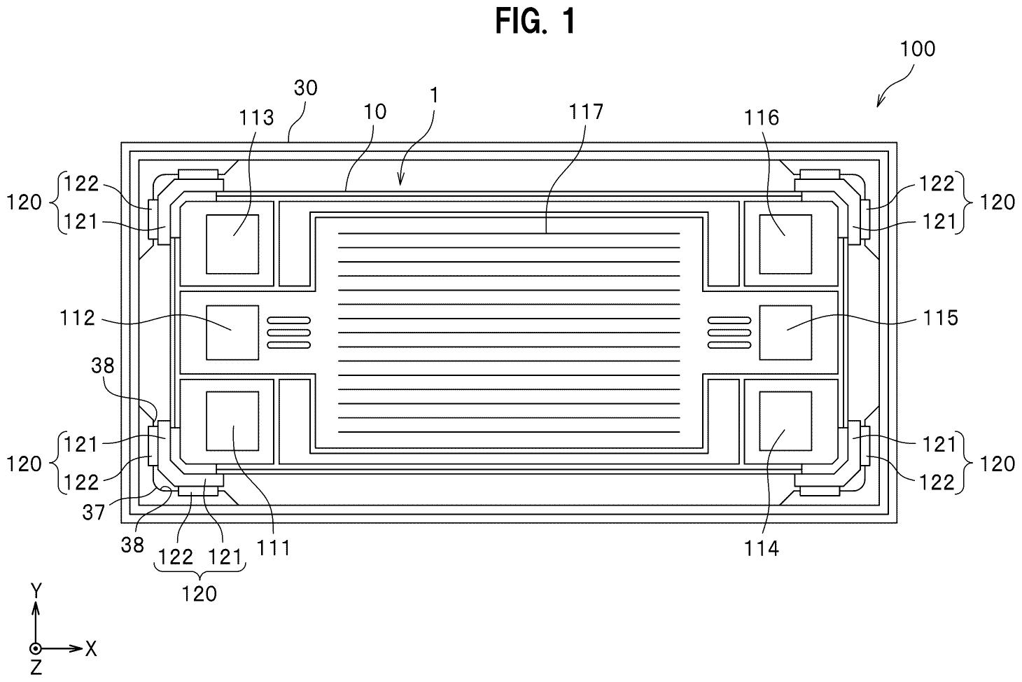

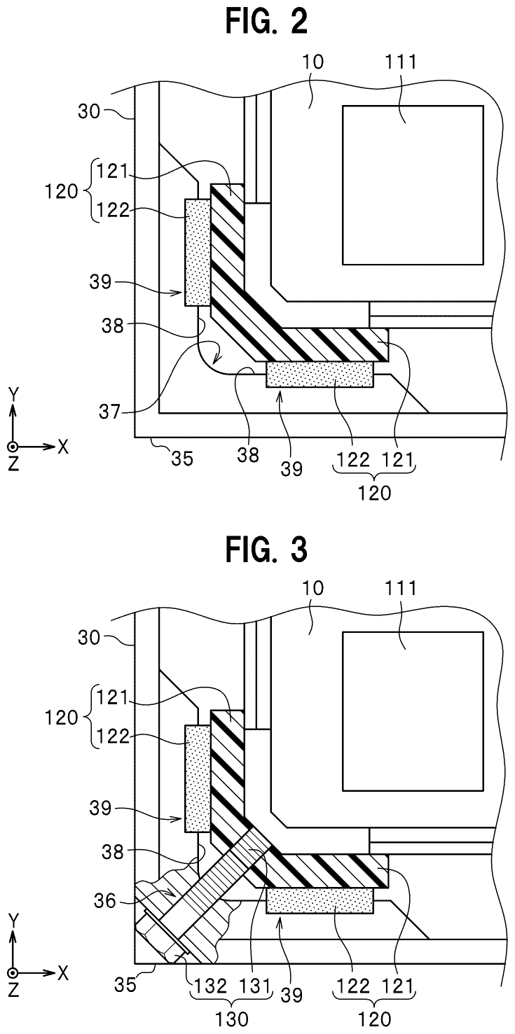

FIG. 1 is a top view of a fuel cell stack according to a first embodiment. FIG. 2 is a partially enlarged view of a lower right end of FIG. 1.

As shown in FIG. 1, the fuel cell stack 100 according to the first embodiment includes a stacked cell 1, a stack case 30, and a buffer member 120.

The stacked cell 1 is configured by stacking a plurality of power generation cells 10 in a Z direction. The power generation cell 10 is, for example, a solid polymer fuel cell having a rectangular shape which is horizontally long (or vertically long) in an X direction. The power generation cell 10 mainly includes a membrane electrode assembly (not shown) and a pair of separators (not shown) disposed on both sides of the membrane electrode assembly (both sides in the Z direction).

The pair of separators also have a rectangular shape that is horizontally long (or vertically long) in the X direction. The separator is formed of, for example, a steel plate, a stainless steel plate, an aluminum plate, a plated steel plate, a metal plate obtained by performing a surface treatment for corrosion prevention on the metal surface, or a carbon member.

The fuel cell stack 100 is mounted on, for example, a fuel cell vehicle by including a stacked cell 1 formed by stacking a plurality of power generation cells 10 in a stack case 30.

An oxidant gas inlet passage 111, a coolant inlet passage 112, and a fuel gas outlet passage 113 are provided along a Y direction at a periphery of one end in a −X direction of the power generation cell 10 forming the stacked cell 1. The oxidant gas inlet passage 111 supplies an oxidant gas, for example, an oxygen-containing gas. The coolant inlet passage 112 supplies a coolant such as pure water, ethylene glycol, or oil. The fuel gas such as a hydrogen-containing gas is discharged through the fuel gas outlet passage 113.

The oxidant gas inlet passage 111 provided in each of the power generation cells 10 is connected to each other in a stacking direction (i.e., the Z direction). The coolant supply passage 112 provided in each of the power generation cells 10 is connected to each other in the stacking direction. The fuel gas outlet passage 113 provided in each of the power generation cells 10 is connected to each other in the stacking direction.

A fuel gas inlet passage 114, a coolant outlet passage 115, and an oxidant gas outlet passage 116 are provided along the Y direction at a periphery of the other end of the power generation cell 10 in the X direction. The fuel gas inlet passage 114 supplies the oxidant gas. The coolant is discharged through the coolant outlet passage 115. The oxidant gas is discharged through the oxidant gas outlet passage 116.

The fuel gas inlet passage 114 provided in each of the power generation cells 10 is connected to each other in the stacking direction. Further, the coolant outlet passage 115 provided in each of the power generation cells 10 is connected to each other in the stacking direction. The oxidant gas outlet passage 116 provided in each of the power generation cells 10 is connected to each other in the stacking direction.

Further, the oxidant gas inlet passage 111 and an oxidant gas flow channel (not shown) that is connected to the oxidant gas outlet passage 116 are provided on a surface of one of the pair of separators closer to the membrane electrode assembly. The fuel gas inlet passage 114 and an oxidant gas flow channel (not shown) that is connected to the fuel cell outlet passage 113 are provided on a surface of the other of the pair of separators closer to the membrane electrode assembly. The coolant inlet passage 112 and a coolant channel 117 that is connected to the coolant outlet passage 115 are provided between surfaces facing each other of the adjacent separators.

As shown in FIG. 1, the oxidant gas inlet passage 111 and the oxidant gas outlet passage 116, the fuel gas inlet passage 114 and the fuel gas outlet passage 113, and the coolant inlet passage 112 and the coolant outlet passage 115 are respectively formed in a first insulating member (or insulator) and an end plate both constituting an end unit of the stacked cell 1.

Next, as shown in FIGS. 1 and 2, the buffer member 120 is disposed at the inner wall corner 37 of the stack case 30. The buffer member 120 includes a resin member 121 and an elastic member 122. The resin member 121 is disposed to face the inner wall corner 37 of the stack case 30. The elastic member 122 is disposed between the resin member 121 and the inner wall surface 38 of the stack case 30.

Further, in the present embodiment, the fuel cell stack 100 is provided with an adjustment mechanism 130 at a corner 35 of the stack case 30.

FIG. 3 is an explanatory view showing a configuration in which an adjustment mechanism is provided at a corner of the stack case. As shown in FIG. 3, an adjustment mechanism 130 that can adjust a distance between the resin member 121 and the inner wall surface 38 of the stack case 30 is provided at the corner 35 of the stack case 30.

As shown in FIG. 3, the resin member 121 is bent along the inner wall corner 37 of the stack case 30 and extends in the stacking direction of the power generation cells 10 (i.e., a Z direction). The adjustment mechanism 130 includes a through hole 36 formed in the stack case 30, a female screw portion 131 formed in the resin member 121, and a bolt 132 inserted into the through hole 36 and screwed into the female screw portion 131. The adjustment mechanism 130 rotates the bolt 132 to move the resin member 121 toward and away from the stack case 30. At this time, the elastic member 122 expands and contracts.

Further, in the first embodiment, the buffer member 120 is attached to the stack case 30. For example, as shown in FIGS. 2 and 3, the fuel cell stack 100 is held by fitting the elastic member 122 of the buffer member 120 into the groove 39 provided on the inner wall surface 38 of the stack case 30.

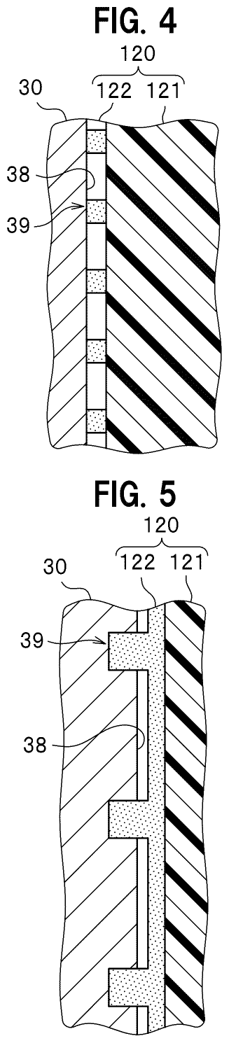

FIG. 4 is an explanatory view showing a state that an elastic member of a buffer member is fitted into a groove provided on an inner wall surface of a stack case. FIG. 4 shows a cross section of the stack case 30 and the buffer member 120 in the stacking direction of the power generation cells 10.

As shown in FIG. 4, the stack case 30 is provided with a buffer member 120, and an elastic member 122 is attached to the groove 39 of the inner wall surface 38. The elastic member 122 does not need to be a single component that is continuous in the stacking direction. Therefore, in FIG. 4, for example, five grooves 39 are formed on the inner wall surface 38, and the elastic members 122 are attached to the five grooves 39, respectively.

Note that FIG. 4 is an example, and the number of the grooves 39 and the number of the elastic members 122 may be, for example, three, and are not limited to these numbers.

A pitch between the adjacent elastic members 122 may be changed in accordance with, for example, load resistance and rubber strength thereof. The elastic member 122 may be formed in a concave-convex shape to be fitted into the groove 39, and may be fixed in position in the stacking direction.

FIG. 5 is a partially enlarged view of a portion of the buffer member of FIG. 4 where the elastic member is attached to the groove of the inner wall surface. As shown in FIG. 5, the elastic member 122 forms a convex portion with respect to the groove 39 of the inner wall surface 38. In this case, the groove 39 of the inner wall surface 38 formed as a recess portion allows the elastic member 122 to be fixed therein in position in the stacking direction.

### [Method for Attaching Buffer Member of Fuel Cell Stack]

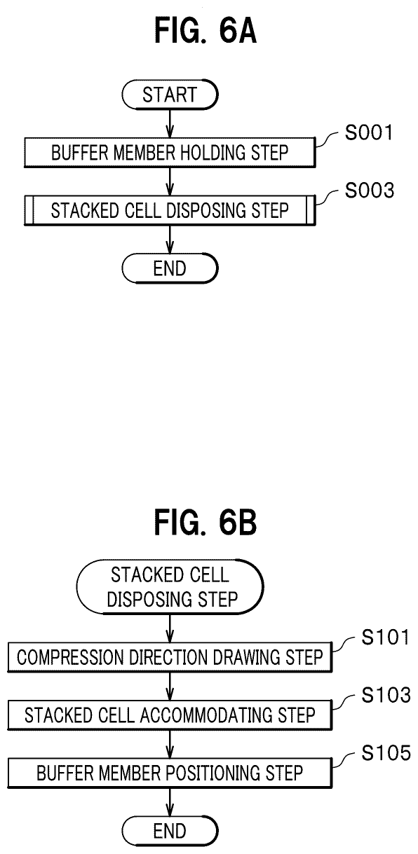

FIG. 6A is a flowchart showing a method for attaching the buffer member 120 to the inner wall surface 38 of the stack case 30 in the fuel cell stack 100.

In the method for attaching the buffer member 120 of the fuel cell stack 100 shown in FIG. 6A, a buffer member holding step (step S001) and a stacked cell disposing step (step S003) are performed.

In the buffer member holding step (step S001), an elastic member 122 of the buffer member 120 is fitted into the groove 39 formed on the inner surface 38 of the stack case 30, thereby holding the buffer member 120.

Next, in the stacked cell disposing step (step S003), a step of disposing the stacked cell 1 inside the stack case 30 in which the buffer member 120 is held is performed in the fuel cell stack 100. More specifically, in the stacked cell disposing step (step S003), a compression direction drawing step (step S101), a stacked cell accommodating step (step S103), and a buffer member positioning step (step S105) shown in FIG. 6B are performed.

FIG. 6B is a flowchart showing the details of the stacked cell disposing step (step S003). In the compression direction drawing step (step S101) in FIG. 6B, after the elastic member 122 is held in the groove 39 of the internal wall surface 38, the adjustment mechanism 130 draws the buffer member 120 disposed at the internal wall corner 37 in the compression direction (i.e., toward the corner 35).

Specifically, a bolt 132 of the adjustment mechanism 130 tightens a female screw portion 131 to draw the resin member 121 into the inner wall corner 37 of the stack case 30. In this case, the resin member 121 facing the inner wall surface 38 is drawn into the inner wall surface 38 of the stack case 30.

Thus, in the fuel cell stack 100, a clearance is formed between the stacked cell 1 (or the power generation cell 10) and the resin member 121.

In the stacked cell accommodating step (step S103) in FIG. 6B, the stacked cell 1 is accommodated in the stack case 30 while the buffer member 120 is being drawn in, in the fuel cell stack 100.

In this case, the stacked cell 1 is accommodated at a predetermined position in the stack case 30 in a state that a predetermined clearance is secured between the stacked cell 1 and the resin member 121 by a positioning guide (not shown) provided in the fuel cell stack 100.

In the buffer member positioning step (step S105) in FIG. 6B, after the stacked cell 1 is accommodated in the stack case 30, the adjustment mechanism 130 discontinues drawing the buffer member, and the bolt 132 is loosened to adjust the gap between the resin member 121 and the stacked cell 1, thereby positioning the buffer member 120, in the fuel cell stack 100.

When the positioning in the buffer member positioning step (step S105) is performed, the flowchart in FIG. 6B is ended and also the stacked cell disposing step (step S003) in the flowchart in FIG. 6A is ended, in the fuel cell stack 100.

As described above the impact receiving structure of the fuel cell stack 100 includes the stacked cell 1 formed by stacking the plurality of power generation cells 10, the stack case 30 in which the stacked cell 1 is accommodated, and the buffer member 120 disposed at the inner wall corner 37 of the stack case 30. The buffer member 120 includes a resin member 121 disposed to face the inner wall corner 37, and an elastic member 122 disposed between the resin member 121 and the inner wall surface 38 of the stack case 30. The elastic member 122 is fitted into and held by a groove 39 provided on an inner wall surface 38 of the stack case 30.

According to the above configuration, in the fuel cell stack 100, the elastic member 122 of the buffer member 120 is fitted into the groove 39 of the inner wall surface 38 of the stack case 30, whereby the buffer member 120 can be attached to the stack case 30. In this case, in the fuel cell stack 100, the elastic member 122 of the buffer member 120 is fitted into the groove 39 of the inner wall surface 38 before the stacked cell 1 in which the power generation cells 10 are stacked is accommodated.

Thus, the impact receiving structure of the fuel cell stack 100 according to the first embodiment can avoid contact between the buffer member 120 and the stacked cell 1. Therefore, in the impact receiving structure of the fuel cell stack 100 according to the first embodiment, the buffer member 120 can be installed in the stack case 30 with high accuracy without damaging the buffer member 120 by contact between the buffer member 120 and a side surface of the stacked cell 1.

Further, the impact receiving structure of the fuel cell stack 100 according to the first embodiment may further include an adjustment mechanism 130 that is provided at a corner 35 of the stack case 30 and is capable of adjusting a distance between the resin member 121 and the inner wall surface 38 of the stack case 30.

According to the above configuration, in the fuel cell stack 100, a distance between the resin member 121 and the inner wall surface 38 of the stack case can be adjusted 30 by the adjustment mechanism 130, allowing a clearance in the resin member 121 to be secured.

Further, in the impact receiving structure of the fuel cell stack 100 according to the first embodiment, the resin member 121 may be bent along the inner wall corner 37 and extend in the stacking direction of the power generation cells 10. In this case, the adjustment mechanism 130 may be configured to include a through hole 36 formed in the stack case 30, a female screw portion 131 formed in the resin member 121, and a bolt 132 inserted into the through hole 36 and screwed into the female screw portion 131.

According to the configuration, the resin member 121 is bent along the inner wall corner 37, and thus the adjustment mechanism 130 can draw the resin member 121 in the drawing direction and in a direction facing the inner wall surface 38 when the resin member 121 is drawn into the corner 35 of the stack case 30. In this case, in the fuel cell stack 100, drawing via the adjustment mechanism 130 can be realized by the female screw portion 131 and the bolt 132. Thereby, the resin member 121 can be easily drawn in by simply tightening the bolt 132.

Further, the resin member 121 can not only be bent along the inner wall corner 37 but also extend in the stacking direction of the power generation cells 10. Thereby, the resin member 121 can be drawn in uniformly and dispersedly also in the stacking direction.

### Second Embodiment

FIG. 7 is an explanatory view showing an impact receiving structure of the fuel cell stack according to the second embodiment. As shown in FIG. 7, in the impact receiving structure of the fuel cell stack 100 according to the second embodiment, the groove 39 of the inner wall surface 38 of the stack case 30 is formed like rails in the stacking direction of the stacked cell 1, and the elastic member 122 is formed in a rail type shape fitted thereto.

The rail type fitting shape of the elastic member 122 shown in FIG. 7 is formed by extrusion molding and is fitted into the groove 39 of the inner wall surface 38 formed in the stacking direction of the stacked cell 1. This feature can prevent a positional displacement in the Y direction. Note that the shape of the groove 39 and the shape of the elastic member 122 are not limited to the above.

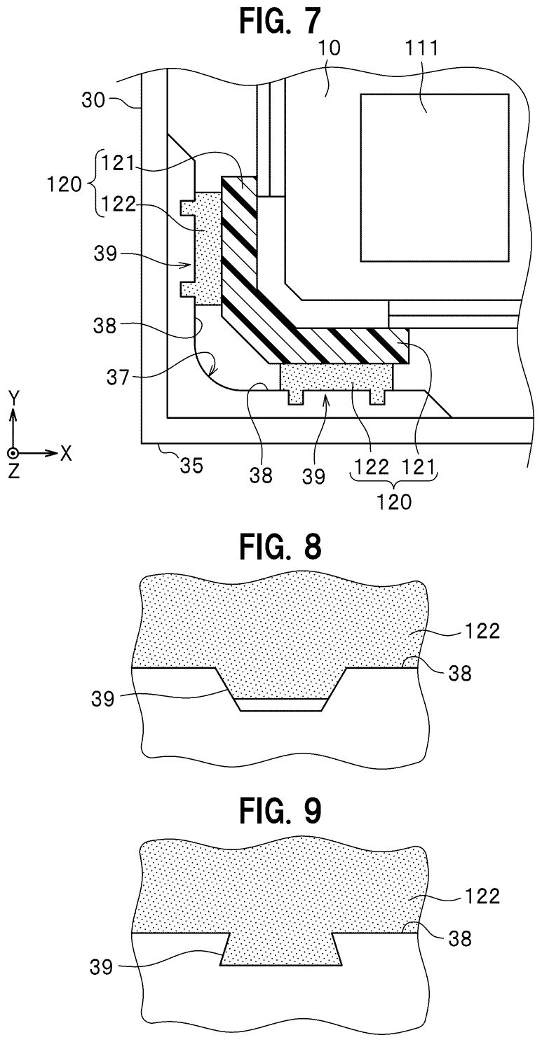

FIG. 8 is an explanatory view showing a configuration in which the groove of the inner wall surface has a tapered shape and the elastic member also has a tapered shape. As shown in FIG. 8, the groove 39 of the inner wall surface 38 and the elastic member 122 are tapered, so that the groove 39 of the inner wall surface 38 allows the elastic member 122 to be fixed therein and to be disposed with its center aligned.

FIG. 9 is an explanatory view showing a configuration in which the groove of the inner wall surface has an inverted taper shape and the elastic member also has an inverted taper shape. As shown in FIG. 9, since the groove 39 of the inner wall surface 38 and the elastic member 122 have the inverted taper shape, the groove 39 of the inner wall surface 38 allows the elastic member 122 to be fixed therein and to be disposed with its center aligned, as in FIG. 8.

The tapered shape of FIG. 8 can be optionally applied to the groove 39 in the stacking direction or the XY plane direction. On the other hand, the inverted taper shape of FIG. 9 is desirably applied to the Z direction with respect to the stacking direction of the stacked cell 1 from a viewpoint of easiness in mounting.

### Third Embodiment

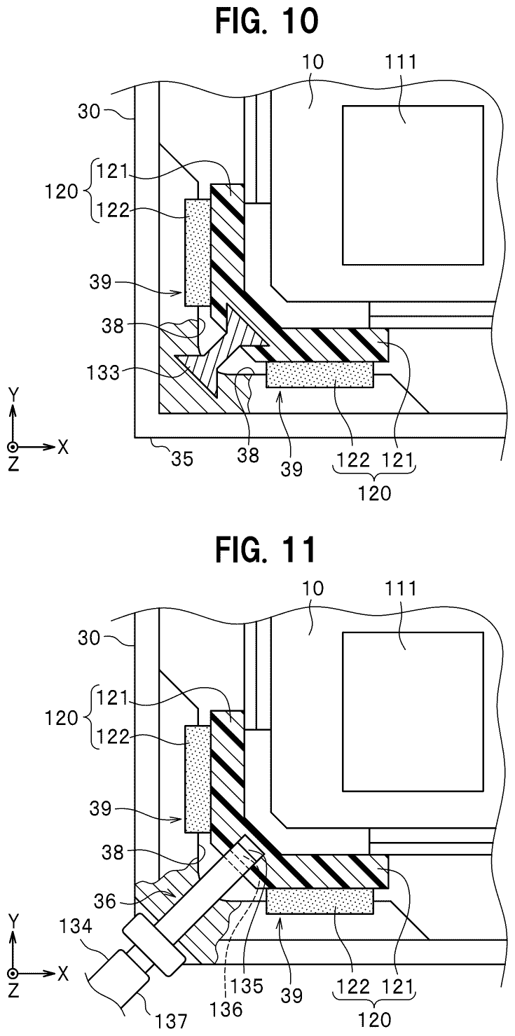

FIG. 10 is an explanatory view showing an impact receiving structure of the fuel cell stack according to the third embodiment. As shown in FIG. 10, in the impact receiving structure of the fuel cell stack 100 according to the third embodiment, the adjustment mechanism 130 is configured by a wedge 133.

In the third embodiment, the adjustment mechanism 130 is configured by the wedge 133, and thus the buffer member holding step (step S003) and the stacked cell disposing step (step S001) shown in FIG. 6A are performed. That is, even when the adjustment mechanism 130 is configured by the wedge 133, the compression direction drawing step (step S101), the stacked cell accommodating step (step S103), and the buffer member positioning step (step S105) shown in FIG. 6B can be performed in the fuel cell stack 100.

The wedge 133 is formed smaller (or shorter) than the resin member 121. For example, in the compression direction drawing step (step S101), the resin member 121 is drawn into the inner wall corner 37 of the stack case 30 by setting (or inserting) the wedge 133 into the resin member 121. Thereby, in the third embodiment, the resin member 121 facing the inner wall surface 38 is drawn into the inner wall surface 38 of the stack case 30, as in the first embodiment.

Accordingly, in the fuel cell stack 100, a clearance is formed between the stacked cell 1 (or the power generation cells 10) and the resin member 121.

In the stacked cell accommodating step (step S103), the stacked cell 1 is accommodated in the stack case 30 while the buffer member 120 is being drawn in by the wedge 133 in the fuel cell stack 100.

In this case, the stacked cell 1 is accommodated at a predetermined position in the stack case 30 in a state that a predetermined clearance is secured between the stacked cell 1 and the resin member 121 by a positioning guide provided in the fuel cell stack 100.

In the buffer member positioning step (step S105), the wedge 133 is removed after the stacked cell 1 is accommodated in the stack case 30, so that the wedge 133 discontinues drawing the buffer member 120. Then, the elastic member 122 expands and the resin member 121 abuts on the stacked cell 1.

Accordingly, in the third embodiment, even when the adjustment mechanism 130 is configured by the wedge 133, the stacked cell disposing step (step S003) can be performed.

### Fourth Embodiment

FIG. 11 is an explanatory view showing an impact receiving structure of the fuel cell stack according to the fourth embodiment. As shown in FIG. 11, in the impact receiving structure of the fuel cell stack 100 according to the fourth embodiment, the adjustment mechanism 130 is configured by a clamp jig 134, a recess portion 135 provided in the resin member 121, and a through hole 36 provided in the stack case 30.

The clamp jig 134 includes, for example, an engagement portion 136 that is inserted into the through hole 36 and engages with the recess portion 135, and a rotary cam mechanism 137 that draws the engagement portion 136.

In the fourth embodiment, the adjustment mechanism 130 includes the through hole 36, the rotary cam mechanism 137 and the engagement portion 136 of the clamp jig 134, and the recess portion 135. Thereby, the buffer member holding step (step S003) and the stacked cell disposing step (step S001) shown in FIG. 6A are performed. That is, even if a distance between the resin member 121 and the inner wall surface 38 of the stack case 30 is adjustable by the rotary cam mechanism 137 of the clamp jig 134, the recess portion 135, and the engagement portion 136, the compression direction drawing step (step S101), the stacked cell accommodating step (step S103), and the buffer member positioning step (step S105) shown in FIG. 6B can be performed in the fuel cell stack 100.

In the first to fourth embodiments, the stacked cell 1 is accommodated in the stack case 30 as it is in the stacked cell accommodating step (step S103) in FIG. 6B, but the present embodiment is not limited thereto.

For example, in the stacked cell accommodating step (step S103), the power generation cells 10 may be stacked in the stack case 30 while the buffer member 120 is being drawn in, and the stacked cell 1 may be accommodated while the stacked cell 1 is formed by stacking the predetermined number of power generation cells 10.

Further, the method for mounting the impact receiver of the fuel cell stack 100 is a method in which the impact receiver of the fuel cell stack 100 is mounted, the fuel cell stack 100 including the stacked cell 1 and the stack case 30. Herein, the fuel cell stack 100 may include the buffer member 120 disposed at the inner wall corner 37 of the stack case 30, and the buffer member 120 may include the resin member 121 and the elastic member 122. In this case, the buffer member holding step (step S001) in which the buffer member 120 is held and the stacked cell disposing step (step S003) can be performed in the method for mounting the impact receiver of the fuel cell stack 100.

Further, in the method for mounting the impact receiver of the fuel cell stack 100, the compression direction drawing step (step S003), the stacked cell accommodating step (step S101), and the buffer member positioning step (step S103) may be performed in the stacked cell disposing step (step S105).

What is claimed is:

1. An impact receiving structure of a fuel cell stack, comprising:
a stacked cell formed by stacking a plurality of power generation cells one another;
a stack case accommodating the stacked cell; and
a buffer member disposed at an inner wall corner of the stack case, wherein
the buffer member includes:
a resin member disposed to face the inner wall corner, and
an elastic member disposed between the resin member and an inner wall surface of the stack case, wherein
the elastic member is fitted into and held by a groove provided on the inner wall surface of the stack case.

2. The impact receiving structure of a fuel cell stack according to claim 1, further comprising:
in a corner of the stack case, an adjustment mechanism configured to adjust a distance between the resin member and the inner wall surface of the stack case.

3. The impact receiving structure of a fuel cell stack according to claim 2, wherein
the resin member is bent along the inner wall corner and extends in a cell stacking direction, and
the adjustment mechanism includes a through hole formed in the stack case, a female screw portion formed in the resin member, and a bolt inserted into the through hole and screwed into the female screw portion.

4. A method for mounting an impact receiver of a fuel cell stack comprising a stacked cell formed by stacking a plurality of power generation cells one another, and a stack case accommodating the stacked cell, wherein
the fuel cell stack includes a buffer member disposed at an inner wall corner of the stack case, and
the buffer member includes a resin member disposed to face the inner wall corner, and an elastic member disposed between the resin member and an inner wall surface of the stack case,
the method comprising:
a step of holding the buffer member by fitting the elastic member into a groove provided on the inner wall surface of the stack case; and
a step of disposing the stacked cell inside the stack case in which the buffer member is held.

5. The method for mounting an impact receiver of a fuel cell stack according to claim 4, the fuel cell stack further comprising, in a corner of the stack case, an adjustment mechanism configured to adjust a distance between the resin member and the inner wall surface of the stack case,
the method comprising:
a step of drawing the buffer member disposed at the inner wall corner in a compression direction by the adjustment mechanism after the elastic member is held,
a step of accommodating the stacked cell in the stack case while the buffer member is being drawn in, and
a step of positioning the buffer member performed by the adjustment mechanism so that the adjustment mechanism discontinues drawing the buffer member, and adjusts a predetermined distance between the resin member and the stacked cell after the stacked cell is accommodated in the stack case.
